(19) United States
(12) Patent Application Publication
(10) Pub. No.: US 2020/0364275 A1
(43) Pub. Date: Nov. 19, 2020

(54) CHARACTERIZING INTERNATIONAL ORIENTATION

(71) Applicant: Microsoft Technology Licensing, LLC, Redmond, WA (US)

(72) Inventors: Yang Liu, Sunnyvale, CA (US); Li Wang, San Carlos, CA (US); Xin Fu, Sunnyvale, CA (US); Wenjing Zhang, Menlo Park, CA (US); Hitesh Manwani, Bangalore (IN)

(73) Assignee: Microsoft Technology Licensing, LLC, Redmond, WA (US)

(21) Appl. No.: 16/410,015

(22) Filed: May 13, 2019

(51) Int. Cl. G06F 16/958; G06F 16/28; G06N 20/00

(52) U.S. Cl. CPC G06F 16/958; G06N 20/00; G06F 16/285

(57) ABSTRACT

The disclosed embodiments provide a system for processing data. During operation, the system obtains labels representing an international orientation or a non-international orientation of a first set of members of an online system, wherein the international orientation includes an interest in or an exposure to foreign entities. Next, the system inputs the labels with features for the first set of members as training data for a machine learning model. The system then applies one or more rules derived from the machine learning model to additional features for a second set of members of the online system to classify some or all members in the second set of members as having the international orientation or the non-international orientation. Finally, the system outputs one or more attributes associated with the classified members for use in improving use of the online system by the members.

### BACKGROUND

### Field

The disclosed embodiments relate to techniques for characterizing international orientation in members of an online system.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for characterizing members of an online system. The online system includes software and/or hardware components that are connected to one another and/or external computer systems via one or more networks. Members of the online system are associated with accounts, authentication credentials, and/or member profiles that allow the members to log in to the online system, interact with one another through the online system, and/or access features of the online system.

More specifically, the disclosed embodiments provide a method, apparatus, and system for characterizing the international orientation or lack of international orientation of members of an online system. In these embodiments, international orientation of a member includes an interest in and/or an exposure by the member to one or more foreign entities where the member is in a certain location or country. For example, a member in a given country may be identified as internationally oriented if he/she has work experience, educational experience, relationships, preferences, and/or other attributes indicating the member's exposure to or interaction with foreign or international companies, schools, people, and/or locations.

To determine if a member is internationally oriented or non-internationally oriented, a set of rules may be applied to features for the member. In some embodiments, the rules include user-defined business rules that identify international orientation based on attributes such as a foreign user interface locale with the online system (e.g., the language and/or region associated with the user interface used by the user to interact with the online system), registration with the online system from a foreign location (e.g., a country that is not a member's current country), and/or foreign work experience. A subset of members that meet the criteria specified in the business rules may be classified as internationally oriented, while remaining members that do not meet the criteria specified in the business rules may be classified based on additional rules associated with attributes of the members.

More specifically, remaining members that cannot be classified using the user-defined rules are clustered, and a label of international orientation or non-international orientation is assigned to each cluster. Labels for the clusters and features for members in the clusters are inputted as training data for a machine learning model, and additional rules are derived from the machine learning model. For example, the labels and features may be used to train a decision tree and/or other type of classification model that predicts the international orientation or non-international orientation of a member. As a result, rules for determining international orientation or non-international orientation of the members may obtained from thresholds, comparisons, and/or conditions applied by the classification model to the features.

The rules are then used to classify some or all of the remaining members as internationally oriented or non-internationally oriented, and attributes associated with the classified members are outputted and/or used to generate recommendations related to use of the online system by the members. For example, the attributes may include engagement metrics related to internationally oriented and non-internationally oriented members, distributions of international orientation and non-international orientation in members of various countries, and/or profile attributes shared by internationally oriented or non-internationally oriented members. In turn, recommendations related to the attributes may include connection recommendations for increasing engagement of internationally oriented and/or non-internationally oriented members with the online system, channels for acquiring additional members within the international or non-international orientation, and/or a product strategy for improving use of the online system by the members.

By identifying attributes related to internationally oriented and non-internationally oriented members of an online system and using the attributes to classify the members, the disclosed embodiments allow numbers, proportions, and/or other metrics related to the distribution of internationally oriented and non-internationally oriented members in different countries to be determined. In turn, such metrics can be used to analyze the usage of the online system by both sets of members, prioritize attributes or preferences related to each set of members, and/or identify strategies or techniques for increasing use of the online system by the members and/or increasing the value of the online system to the members.

Identification of members as internationally oriented or non-internationally-oriented additionally allows recruiters and/or other users to search for members by international orientation or non-international orientation. For example, a recruiter for a multi-national company can search for internationally oriented members that meet the qualifications of positions in the company to identify potential candidates that are more likely to be interested in the positions and/or company. Conversely, a recruiter for a local company in a given country can search for non-internationally-oriented members in the same country to find potential candidates that are more likely to be interested in locally oriented companies and/or positions.

In contrast, conventional techniques may lack the ability to distinguish between internationally oriented and non-internationally oriented users, or may perform coarse-grained classification of users as internationally oriented or non-internationally oriented based on arbitrary rules and/or heuristics. Thus, the conventional techniques may fail to characterize and/or may mischaracterize the users' interest in or exposure to international or foreign entities. In turn, the conventional techniques may lack the ability to generate or derive accurate insights from attributes related to internationally oriented and/or non-internationally oriented users, which may result in sub-optimal user experiences, adoption, and/or usage of online systems by the users. The conventional techniques may further require recruiters to manually review member profiles to determine the members' international or non-international orientation, which is time consuming and inefficient and can result in additional backend processing to serve the profiles in response to searching and/or browsing behavior by the recruiters. Consequently, the disclosed embodiments may improve computer systems, applications, user experiences, tools, and/or technologies related to user recommendations, user targeting, user segmentation, human-computer interaction, product strategy, and/or online systems.

### Characterizing International Orientation

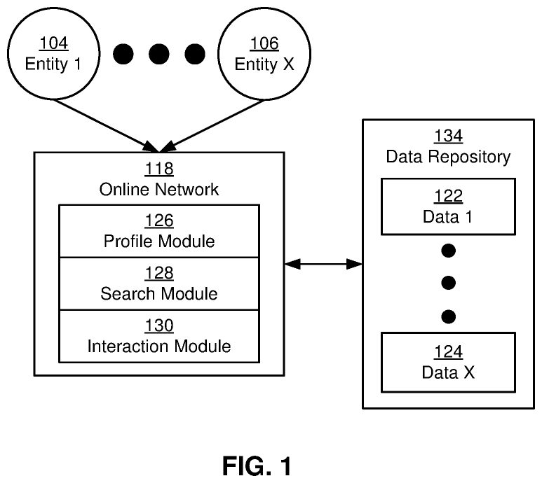

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

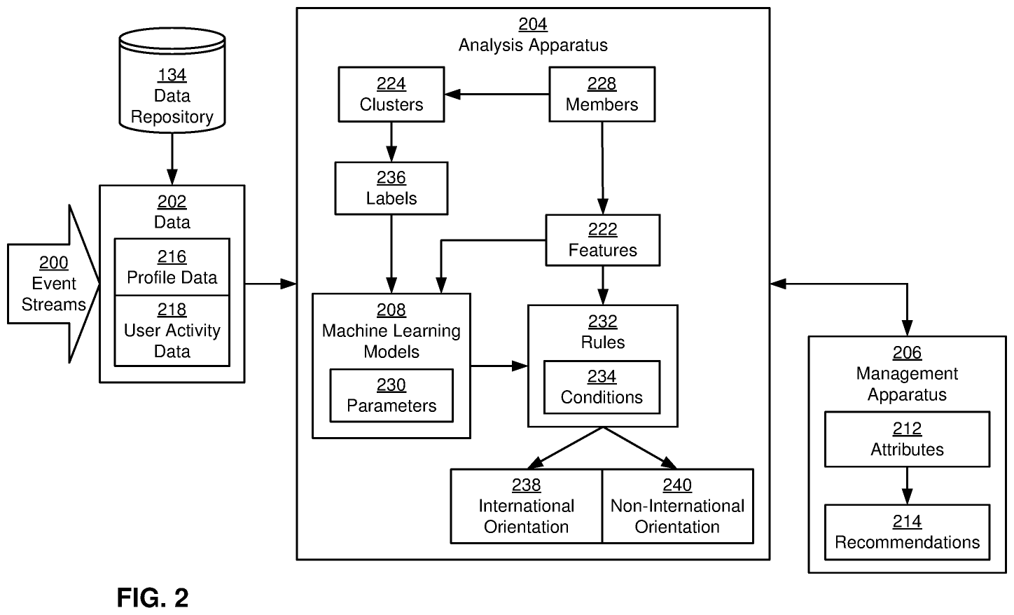

As shown in FIG. 2, data repository 134 and/or another primary data store may be queried for data 202 that includes profile data 216 for members of an online system (e.g., online network 118 of FIG. 1), as well as user activity data 218 that tracks the members' activity within and/or outside the online system. Profile data 216 includes data associated with member profiles in the online system. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online system.

Attributes of the members from profile data 216 may be matched to a number of member segments, with each member segment containing a group of members that share one or more common attributes. For example, member segments in the online system may be defined to include members with the same industry, title, location, and/or language.

Connection information in profile data 216 may additionally be combined into a graph, with nodes in the graph representing entities (e.g., users, schools, companies, locations, etc.) in the online system. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 includes records of member interactions with one another and/or content associated with the online system. For example, user activity data 218 may track impressions, clicks, likes, dislikes, shares, hides, comments, posts, updates, conversions, and/or other user interaction with content in the online system. User activity data 218 may also track other types of activity, including connections, messages, and/or interaction with groups or events. Like profile data 216, user activity data 218 may be used to create a graph, with nodes in the graph representing members and/or content and edges between pairs of nodes indicating actions taken by members, such as creating or sharing articles or posts, sending messages, sending or accepting connection requests, joining groups, and/or following other entities.

In one or more embodiments, data repository 134 stores data 202 that represents standardized, organized, and/or classified attributes. For example, skills in structured jobs data 216 and/or unstructured jobs data 218 may be organized into a hierarchical taxonomy that is stored in data repository 134. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

Data 202 in data repository 134 may further be updated using records of recent activity received over one or more event streams 200. For example, event streams 200 may be generated and/or maintained using a distributed streaming platform such as Apache Kafka (Kafka™ is a registered trademark of the Apache Software Foundation). One or more event streams 200 may also, or instead, be provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the system may be generated in response to the activity. The record may then be propagated to components subscribing to event streams 200 on a nearline basis.

An analysis apparatus 204 uses profile data 216, user activity data 218, and/or other data 202 in data repository 134 to determine an international orientation 238 or a non-international orientation 240 of some or all members 228 of the online system. In some embodiments, international orientation 238 includes an interest in and/or an exposure to foreign entities by members in a certain location, and non-international orientation 240 includes a lack of interest in and/or exposure to foreign entities by members in the same location. For example, a member may be identified as having international orientation 238 or non-international orientation 240 based on the presence or absence of foreign companies, schools, connections, places of residence, and/or other types of entities in the member's profile data 216 and/or user activity data 218.

More specifically, analysis apparatus 204 applies a set of rules 232 to features 222 for members 228 to classify or characterize some or all members 228 as having either international orientation 238 or non-international orientation 240. Features 222 include attributes that are obtained and/or derived from profile data 216 and/or user activity data 218 for members 228. For example, analysis apparatus 204 may obtain features from data repository 134 and/or another data store and/or calculate features from data in the data store.

In one or more embodiments, features 222 for members 228 include indicators of the members' interest in and/or exposure to foreign entities. For example, features 222 may include binary features that indicate whether or not a member has a foreign user interface locale with the online system (e.g., a foreign language and/or region setting associated with the user interface used by the member to access the online system), work experience at a foreign or multinational company, education experience at a foreign school, and/or registration with the online system from a foreign location outside the member's current country (e.g., based on the Internet Protocol (IP) address associated with the registration). Features 222 may also, or instead, include numeric features such as a proportion of the member's connections that are foreign and/or a proportion of profile views performed by the member that are of members in other countries.

In one or more embodiments, rules 232 include one or more user-defined rules 232 that are applied to features 222 to classify a subset of members 228 with respect to international orientation 238 and/or non-international orientation 240. For example, the user-defined rules 232 may include a rule that is applied to features 222 that include a member's user interface locale with the online system, employer, school, and/or location of registration with the online system. The rule may identify a given member as having international orientation 238 when the member has a foreign interface locale and has also worked for a foreign company, studied at a foreign school, and/or registered with the online system from a foreign location. The user-defined rules 232 may also, or instead, include another rule that identifies a member as “unclassifiable” (i.e., unable to be assigned to neither international orientation 238 nor non-international orientation 240) when the member lacks profile data 216 or features 222 generated from profile data 216 and/or fewer than a threshold number of connections in the online system.

To identify additional members 228 as having international orientation 238 or non-international orientation 240, analysis apparatus 204 determines additional rules 232 for classifying the members based on features 222 and labels 236 for the members. In one or more embodiments, analysis apparatus 204 obtains labels 236 based on clusters 224 of members 228 with similar features 222 and/or attributes. For example, analysis apparatus 204 may use a k-means clustering technique and/or another clustering technique to divide members 228 that have not yet been classified (or deemed unclassifiable) by user-defined rules 232 into multiple clusters 224, with each cluster containing a subset of members 228 with common and/or similar features 222. Thus, each cluster may be represented by a different combination of values for binary features 222 representing a foreign user interface locale with the online system, employment at a foreign or multinational company, education at a foreign school, registration with the online system from a foreign location, and/or values of numeric features that include a large proportion of foreign connections and/or a large proportion of profile views that are of foreign members.

After clusters 224 are created, analysis apparatus 204 obtains labels 236 identifying each cluster as belonging to international orientation 238, belonging to non-international orientation 240, and/or as being unclassifiable. For example, analysis apparatus 204 and/or another component may output values of features 222 representing each cluster and/or profile data 216 for members 228 in the cluster to one or more users, and the user(s) may manually label the cluster and/or members 228 in the cluster as having international orientation 238, non-international orientation 240, or neither international orientation 238 nor non-international orientation 240.

Analysis apparatus 204 then generates additional rules 232 for classifying additional members 228 by training one or more machine learning models 208 using features 222 and labels 236 for clusters 224 of members 228. For example, analysis apparatus 204 may use a training technique and/or one or more hyperparameters to update parameters 230 (e.g., coefficients, weights, etc.) of machine learning models 208 so that machine learning models 208 learn to predict labels 236 for clusters 224 based on the corresponding features 222. After parameters 230 are created and/or updated, analysis apparatus 204 may store parameters 230 in data repository 134 and/or another data store for subsequent retrieval and use.

In turn, analysis apparatus 204 derives one or more additional rules 232 for characterizing members 228 as having international orientation 238 and/or non-international orientation 240 based on parameters 230 of machine learning models 208. For example, machine learning models 208 may include a decision tree that specifies true/false conditions 234 to be applied to features 222. As a result, rules 232 may include a subset of conditions 234 that have the highest values of accuracy, purity, precision, and/or recall in the decision tree.

After one or more rules 232 for characterizing members 228 as internationally oriented or non-internationally oriented are obtained from parameters 230 of a given machine learning model, analysis apparatus 204 optionally generates additional clusters 224 of members 228 that remain unclassified after existing rules 232 have been applied to the corresponding features 222. Analysis apparatus 204 may also obtain additional labels 236 for the newly created clusters 224 and train one or more additional machine learning models 208 to predict labels 236 based on features 222 for members 228 in the newly created clusters 224. Analysis apparatus 204 may then use parameters 230 of the additional machine learning models 208 to identify additional rules 232 that can be used to characterize international orientation 238 and/or non-international orientation 240 in members 228.

For example, analysis apparatus 204 may divide members 228 that have not been classified as having international orientation 238 or that have been flagged as “unclassifiable” by the user-defined rules 232 described above into three general groups. A first group includes members 228 that lack a foreign user interface locale, foreign work experience, foreign education experience, views of foreign profiles, and/or foreign connections. A second group includes members 228 that have a foreign user interface locale but lack foreign work experience and foreign education experience. The third group includes members 228 that do not have a foreign user interface locale but have foreign work experience, foreign education, views of foreign profiles, and/or foreign connections.

Continuing with the above example, analysis apparatus 204 may apply k-means clustering to the second and third groups to generate clusters 224 of members 228 within each group. Analysis apparatus 204 may obtain user-generated labels 236 for the generated clusters 224 and train a separate decision tree to predict labels 236 for clusters 224 in each of the second and third groups based on features 222 that represent members 228 of clusters 224. After the decision trees are created, analysis apparatus 204 may identify rules 232 for classifying members 228 with respect to international orientation 238 and non-international orientation 240 from conditions 234 in the decision trees. Such rules 232 and/or conditions 234 may include, but are not limited to, identifying a member as having international orientation 238 when the member has foreign education, foreign work experience, a significant proportion of foreign connections, a significant proportion of foreign profile views, and/or a foreign user interface locale and registration with the online system from a different country. Such rules 232 and/or conditions 234 may also, or instead, include identifying a member as having non-international orientation 240 when the member has non-foreign (i.e., local) education, non-foreign work experience, non-foreign user interface locale, and non-foreign registration with the online system and/or when the member has an insignificant proportion of foreign profile views and/or foreign connections.

Continuing with the above example, analysis apparatus 204 may use conditions 234 and/or rules 232 obtained from the decision trees to identify a fourth group to be classified as containing members 228 that have only one of a foreign user interface locale, foreign registration with the online system, multinational company work experience, a significant proportion of foreign connections, and/or a significant proportion of views of foreign profiles. Analysis apparatus 204 may apply k-means clustering to the first and fourth groups to generate additional clusters 224 of members 228 within each group. Analysis apparatus 204 may also obtain user-generated labels 236 for the generated clusters 224 and train one or more additional decision trees to predict labels 236 for clusters 224 in the first and fourth groups based on features 222 that represent members 228 of the clusters. Analysis apparatus 204 may then use one or more conditions 234 of the decision tree(s) to generate an additional rule that classifies a member as having international orientation 238 when the member has multinational work experience and also has a foreign user interface locale, or has a significant proportion of foreign connections and/or foreign profile views.

Analysis apparatus 204 may additionally merge user-defined rules 232 and rules 232 derived from conditions 234 of machine learning models 208 to produce an overall set of rules 232 for characterizing and/or classifying members 228 as having international orientation 238 or non-international orientation 240. Continuing with the above example, analysis apparatus 204 may determine that a member has international orientation 238 when any of the following four conditions 234 are met:
at least 20% of the member's connections are foreign
the member has foreign education experience
the member registered with the online system from a foreign country and uses a foreign user interface locale with the online system
the member has worked for a multinational company and uses a foreign user interface locale with the online system
   Conversely, analysis apparatus 204 may determine that a member has non-international orientation 238 when the member lacks foreign education, foreign work experience, foreign connections, foreign profile views, foreign user interface locale, and foreign registration with the online system.

After a final set of rules 232 is produced, analysis apparatus 204 uses rules 232 to classify additional members 228 as having international orientation 238 or non-international orientation 240, and a management apparatus 206 determines one or more attributes 212 associated with the classified members 228. For example, analysis apparatus 204 may apply rules 232 to members 228 to identify one subset of members 228 as having international orientation 238 and another subset of members 228 as having non-international orientation 240. Management apparatus 206 may use the subsets of members 228 to calculate numbers or proportions of members 228 in a given country that have international orientation 238 and non-international orientation 240. Management apparatus 206 may also, or instead, generate distributions of international orientation 238, non-international orientation 240, and unclassifiability in members 228 located in various countries. Management apparatus 206 may also, or instead, identify demographic attributes (e.g., ages, locations, industries, job functions, levels of education, seniorities, etc.), engagement metrics related to the online system (e.g., number of user sessions, length of user sessions, length of membership with the online system, connection density, connection count, etc.), and/or usage patterns related to the online system (e.g., acquisition channels, modules used, purchases, subscriptions, premium memberships, etc.) shared by internationally oriented or non-internationally oriented members.

Management apparatus 206 also generates recommendations 214 based on attributes 212. For example, management apparatus 206 may output attributes 212 as insights related to members 228 with international orientation 238 and non-international orientation 240 for a given country and/or for comparison across countries. In turn, the insights may be used by administrators and/or managers of the online system to target internationally and/or non-internationally oriented members 228 based on attributes 212. In another example, management apparatus 206 may generate and/or output connection recommendations for increasing engagement with the online system, such as connection recommendations that encourage non-internationally oriented members that are generally less active and/or engaged to connect with internationally oriented members that are generally more active and/or engaged. In a third example, management apparatus 206 may identify different channels (e.g., partnerships, search engine optimization, web-based channels, mobile channels, email channels, app stores, etc.) for acquiring additional members with international orientation 238 or non-international orientation 240 based on the distributions of channels used by members with international orientation 238 and members with non-international orientation 240 to register with the online system. In a fourth example, management apparatus 206 may recommend a product strategy that includes interests, priorities, and/or characteristics of members 228 with international orientation 238 or non-international orientation 240 to improve use of the online system by members 228.

In a fifth example, management apparatus 206 may allow a recruiter and/or another type of user to search for and/or filter members by international orientation 238 or non-international orientation 240. Management apparatus 206 may also, or instead, recommend candidates for targeting with jobs, sales, marketing, and/or other types of opportunities based on by international orientation 238 or non-international orientation 240. As a result, management apparatus 206 may allow the user to match a local or international scope of recruiting, sales, marketing, advertising, and/or other types of activity to a corresponding set of members.

By identifying attributes 212 related to internationally oriented and non-internationally oriented members 228 of the online system and using the attributes to classify members 228, the system of FIG. 2 allows numbers, proportions, and/or other metrics related to the distribution of internationally oriented and non-internationally oriented members in different countries to be determined. In turn, such metrics can be used to analyze the usage of the online system by both sets of members 228, prioritize attributes or preferences related to each set of members 228, and/or identify strategies or techniques for increasing use of the online system by members 228 and/or increasing the value of the online system to members 228.

In contrast, conventional techniques may lack the ability to distinguish between internationally oriented and non-internationally oriented users, or may perform coarse-grained classification of users as internationally oriented or non-internationally oriented based on arbitrary rules and/or heuristics. Thus, the conventional techniques may fail to characterize and/or may mischaracterize the users' interest in or exposure to international or foreign entities. In turn, the conventional techniques may lack the ability to generate or derive accurate insights from attributes related to internationally oriented and/or non-internationally oriented users, which may result in sub-optimal user experiences, adoption, and/or usage of online systems by the users. Consequently, the disclosed embodiments may improve computer systems, applications, user experiences, tools, and/or technologies related to user recommendations, user targeting, user segmentation, human-computer interaction, product strategy, and/or online systems.

Those skilled in the art will appreciate that the system of FIG. 2 may be implemented in a variety of ways. First, analysis apparatus 204, management apparatus 206, and/or data repository 134 may be provided by a single physical machine, multiple computer systems, one or more virtual machines, a grid, a cluster, one or more databases, one or more filesystems, and/or a cloud computing system. Analysis apparatus 204 and management apparatus 206 may additionally be implemented together and/or separately by one or more hardware and/or software components and/or layers.

Second, a number of techniques may be used to obtain rules 232, conditions 234, parameters 230, and/or attributes 212. For example, the functionality of machine learning models 208 may be provided by a regression model, artificial neural network, support vector machine, decision tree, random forest, gradient boosted tree, naïve Bayes classifier, Bayesian network, clustering technique, collaborative filtering technique, deep learning model, hierarchical model, and/or ensemble model. The retraining or execution of each machine learning model may also be performed on an offline, online, and/or on-demand basis to accommodate requirements or limitations associated with the processing, performance, or scalability of the system and/or the availability of features 222 and/or labels 236 used to train the machine learning model. Multiple versions of each machine learning model may further be adapted to different subsets of members 228, clusters 224, and/or features 222 (e.g., members from different countries, members with different values and/or ranges of values of features 222, etc.), or the same machine learning model 208 may be used to generate rules 232 for classifying all members 228 in the online system as having international orientation 238, non-international orientation 240, or neither.

Third, the system of FIG. 2 may be adapted to classify other characteristics and/or behavior related to members 228. For example, the system may be used to infer and/or predict user behavior, preferences, and/or outcomes related to topics, groups, hobbies, activities, events, professional development, learning, online dating matches, and/or job applications.

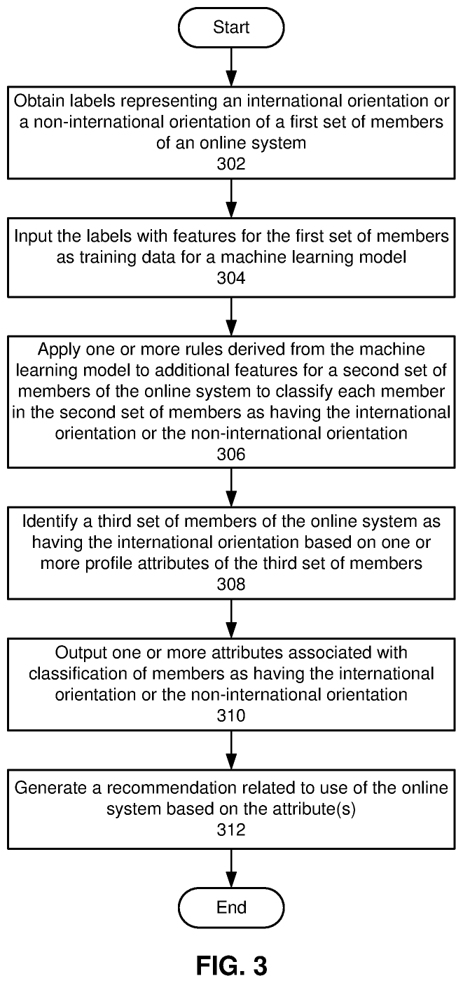

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, labels representing an international orientation or a non-international orientation of a first set of members of an online system are obtained (operation 302). For example, the first set of members may include members that could not be classified as having an international orientation or a non-international orientation using one or more user-defined rules. The first set of members may be clustered, and a label of international orientation or non-international orientation may be obtained for each of the clusters.

Next, the labels are inputted with features of the first set of members as training data for a machine learning model (operation 304). For example, the features may include binary features that indicate whether or not a member has a foreign user interface locale with the online system, foreign or multinational work experience, foreign education, and/or a foreign registration with the online system. The features may also, or instead, include numeric features such as a proportion of the member's connections that are foreign and/or a proportion of the member's profile views that are of members in other countries. After the features and labels are used as training data for the machine learning model, the machine learning model may learn to predict the labels based on features for the corresponding clusters of members.

One or more rules derived from the machine learning model are applied to additional features for a second set of members of the online system to classify each member in the second set of members as having the international orientation or the non-international orientation (operation 306). For example, the rules may be generated from a subset of thresholds, conditions, and/or parameters with the highest purity, accuracy, precision, and/or recall from a tree-based model that a member as internationally oriented or non-internationally oriented based on features for the member. When a condition specified in a rule is met by a corresponding set of features, the member may be classified accordingly. In another example, the rules may include statistically significant regression coefficients from a logistic regression model that classifies members as internationally oriented or non-internationally oriented. The regression coefficients may be combined with the member features to obtain output that predicts the international orientation or non-international orientation of a corresponding member.

A third set of members of the online system is identified as having the international orientation based on one or more profile attributes of the third set of members (operation 308). For example, the third set of members may be identified using one or more user-defined rules that specify that an international orientation of a member when the member has a foreign user interface locale with the online system, as well as foreign work experience and/or registration with the online system from a foreign location.

One or more attributes associated with classification of members as having the international orientation or the non-international orientation are then outputted (operation 310), and a recommendation related to use of the online system is generated based on the attribute(s) (operation 312). For example, the attributes may include a metric related to members that are internationally oriented or non-internationally oriented, a distribution of international orientation and non-international orientation in members of various countries, and/or a profile attribute shared by members with international orientation or non-international orientation. In turn, the recommendation may include a connection recommendation for increasing engagement with the online system, a channel for acquiring additional members with the international orientation or the non-international orientation, and/or a product strategy for improving use of the online system by members in various countries.

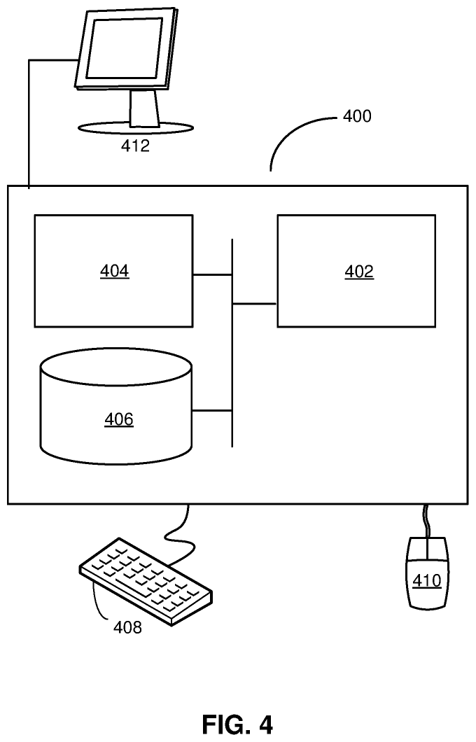

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system includes an analysis apparatus and a management apparatus, one or more of which may alternatively be termed or implemented as a module, mechanism, or other type of system component. The analysis apparatus obtains labels representing an international orientation or a non-international orientation of a first set of members of an online system. Next, the analysis apparatus inputs the labels with features for the first set of members as training data for a machine learning model. The analysis apparatus then applies one or more rules derived from the machine learning model to additional features for a second set of members of the online system to classify some or all members in the second set of members as having the international orientation or the non-international orientation. Finally, the management outputs one or more attributes associated with the classified members for use in improving use of the online system by the members.

In addition, one or more components of computer system 400 may be remotely located and connected to the other components over a network. Portions of the present embodiments (e.g., analysis apparatus, management apparatus, data repository, online network, etc.) may also be located on different nodes of a distributed system that implements the embodiments. For example, the present embodiments may be implemented using a cloud computing system that characterizes the international orientation or lack of international orientation of remote members of an online system.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is riot.intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining labels representing an international orientation or a non-international orientation of a first set of members of an online system, wherein the international orientation comprises an interest in or an exposure to one or more foreign entities;
inputting, by one or more computer systems, the labels with features for the first set of members as training data for a machine learning model;
applying, by the one or more computer systems, one or more rules derived from the machine learning model to additional features for a second set of members of the online system to classify some or all members in the second set of members as having the international orientation or the non-international orientation; and
outputting one or more attributes associated with the classified members for use in improving use of the online system by the second set of members.

2. The method of claim 1, further comprising:
identifying a third set of members of the online system as having the international orientation based on one or more profile attributes of the third set of members.

3. The method of claim 2, wherein the one or more profile attributes comprise a foreign user interface locale for the online system.

4. The method of claim 3, wherein the one or more profile attributes further comprise at least one of:
foreign work experience; and
registration with the online system from a foreign location.

5. The method of claim 1, wherein obtaining the labels representing the international orientation or the non-international orientation of the first set of members of the online system comprises:
generating clusters of the first set of members; and
obtaining a label of the international orientation or the non-international orientation for each of the clusters.

6. The method of claim 1, wherein applying the one or more rules derived from the machine learning model to the additional features for the second set of members comprises:
creating the one or more rules from a subset of parameters for the machine learning model.

7. The method of claim 1, wherein the features comprise a proportion of foreign connections for a member.

8. The method of claim 7, wherein the one or more rules comprise a minimum threshold for the proportion of foreign connections for the member to have the international orientation.

9. The method of claim 1, wherein the one or more rules comprise foreign education experience for a member to have the international orientation.

10. The method of claim 1, further comprising:
generating a recommendation related to use of the online system based on the one or more attributes.

11. The method of claim 10, wherein the recommendation comprises at least one of:
a connection for increasing engagement with the online system;
a channel for acquiring additional members with the international orientation or the non-international orientation; and
a product strategy for improving use of the online system by the second set of members.

12. The method of claim 1, wherein the one or more attributes associated with the classified second set of members comprises at least one of:
a metric related to the classified second set of members;
a distribution of the international orientation and the non-international orientation in the classified second set of members; and
a profile attribute shared by members with the international orientation or the non-international orientation.

13. A system, comprising:
one or more processors; and
memory storing instructions that, when executed by the one or more processors, cause the system to:
obtain labels representing an international orientation or a non-international orientation of a first set of members of an online system, wherein the international orientation comprises an interest in or an exposure to one or more foreign entities;
input the labels with features for the first set of members as training data for a machine learning model;
apply one or more rules derived from the machine learning model to additional features for a second set of members of the online system to classify some or all members in the second set of members as having the international orientation or the non-international orientation; and
output one or more attributes associated with the classified members for use in improving use of the online system by the classified members.

14. The system of claim 13, wherein the memory further stores instructions that, when executed by the one or more processors, cause the system to:
identify a third set of members of the online system as having the international orientation based on one or more profile attributes of the third set of members.

15. The system of claim 14, wherein the one or more profile attributes comprise at least one of:
a foreign user interface locale for the online system;
foreign work experience; and
registration with the online system from a foreign location.

16. The system of claim 13, wherein obtaining the labels representing the international orientation or the non-international orientation of the first set of members of the online system comprises:
generating clusters of the first set of members; and
obtaining a label of the international orientation or the non-international orientation for each of the clusters.

17. The system of claim 13, wherein applying the one or more rules derived from the machine learning model to the additional features for the second set of members comprises:
creating the one or more rules from one or more conditions in a decision tree.

18. The system of claim 13, wherein the one or more rules comprise at least one of:
a minimum threshold for a proportion of foreign connections for a member to have the international orientation; and
foreign education experience for the member to have the international orientation.

19. The system of claim 13, wherein the one or more foreign entities comprise at least one of:
a company;
a school;
a location; and
a member.

20. A non-transitory computer-readable storage medium storing instructions that when executed by a computer cause the computer to perform a method, the method comprising:
obtaining labels representing an international orientation or a non-international orientation of a first set of members of an online system, wherein the international orientation comprises an interest in or an exposure to one or more foreign entities;
inputting the labels with features for the first set of members as training data for a machine learning model;
applying one or more rules derived from the machine learning model to additional features for a second set of members of the online system to classify some or all members in the second set of members as having the international orientation or the non-international orientation; and
outputting one or more attributes associated with the classified members for use in improving use of the online system by the classified members.
